(19) United States
(12) Patent Application Publication
(10) Pub. No.: US 2012/0117034 A1
(43) Pub. Date: May 10, 2012

(54) CONTEXT-AWARE APPARATUS AND METHOD

(75) Inventors: Chi-Yoon JEONG, Daejeon (KR); Beom-Hwan Chang, Daejeon (KR)

(73) Assignee: Electronics and Telecommunications Research Institute, Daejeon (KR)

(21) Appl. No.: 13/289,238

(22) Filed: Nov. 4, 2011

(30) Foreign Application Priority Data
Nov. 4, 2010 (KR) 10-2010-0109314

(51) Int. Cl. G06F 17/30

(52) U.S. Cl. 707/687; 707/E17.007

(57) ABSTRACT

Disclosed herein is a context-aware apparatus and method. The context-aware apparatus includes a microblog monitoring unit, a web information collection unit, a microblog information collection unit, and a context-aware information creation unit. The microblog monitoring unit monitors the written information of one or more microblogs, and extracts at least one keyword corresponding to a set topic from the written information. The web information collection unit collects web information corresponding to the keyword from webpages. The microblog information collection unit collects microblog information corresponding to the written information including the keyword from the microblogs. The context-aware information creation unit creates context-aware information using the web information and the microblog information.

### CROSS REFERENCE TO RELATED APPLICATION

This application claims the benefit of Korean Patent Application No. 10-2010-0109314, filed Nov. 4, 2010, which is hereby incorporated by reference in its entirety into this application.

### BACKGROUND OF THE INVENTION

1. Technical Field

The present invention relates generally to a context-aware apparatus and method and, more particularly, to an apparatus and method that is capable of becoming aware of the context using the web and a microblog service.

2. Description of the Related Art

A microblog service refers to a blog service that provides information using short sentences. Representative microblog services include Twitter, me2day (a Korean service), etc.

In general, a blog has the operational burden of having to develop a serious topic in a logical fashion. In contrast, a microblog allows ideas coming to one's mind at random or simple information to be written using short sentences, and therefore a microblog service has the advantage of enabling users to easily and quickly write information, compared to other social network services including a blog service.

Recently, due to the advantage of enabling users to conveniently write information while moving around thanks to the advent of smart phones, the number of users who are using microblogs is gradually increasing. Furthermore, information written using a microblog service is written and propagated more rapidly than information created using existing services.

Unlike the information of a microblog service, the information of existing social network services or the information existing on the Internet in webpage form provides detailed information about a specific topic. Since large amounts of material and time are required to write information, there is the disadvantage of their not being updated frequently.

Currently, early warning systems for becoming aware of an abnormal context, such as an Internet intrusion, analyze Internet information updated at relatively long intervals, predict the occurrence of an abnormal context based on analysis results, and then create information, and they are limited in predicting and alarming abrupt attacks such as a zero-day attack.

Information searches that have been performed so far have considered microblog service information and web information to be different types of information in different domains, and are performed only on information in a corresponding domain.

Recently, a system has been developed for presenting Internet search results as well as the search term-related text of microblog services with respect to an input search term. However, this system remains at a level where it simply performs searches related to search terms, searching the text of microblog services and representing search results, and is limited in analyzing Internet search results and microblog service results in an integrated fashion and creating new information.

### SUMMARY OF THE INVENTION

Accordingly, the present invention has been made keeping in mind the above problems occurring in the prior art, and an object of the present invention is to provide an apparatus and method that is capable of becoming aware of the context using the web and a microblog service.

In order to accomplish the above object, the present invention provides a context-aware apparatus, including a microblog monitoring unit for monitoring the written information of one or more microblogs, and extracting at least one keyword corresponding to a set topic from the written information; a web information collection unit for collecting web information corresponding to the keyword from webpages; a microblog information collection unit for collecting microblog information corresponding to the written information including the keyword from the microblogs; and a context-aware information creation unit for creating context-aware information using the web information and the microblog information.

The written information may correspond to information that was written by users of the microblogs based on monitoring results that are obtained in such a way that the users monitor information related to an abnormal context corresponding to at least one of a cyber attack, a natural disaster, gas leakage, and a traffic context.

The microblog monitoring unit may include an information storage module for storing multimedia information that is used to represent the written information; an information reception module for accessing the microblogs and receiving the written information; a correlation determination module for analyzing a correlation between the multimedia information and the written information and determining whether the written information is information corresponding to the abnormal context based on analysis results; and a keyword extraction module for extracting at least one keyword corresponding to the abnormal context from the written information if the written information is information corresponding to the abnormal context.

The web information collection unit may include a search module for collecting webpages including the keyword; a cluster creation module for analyzing the collected webpages and clustering analysis results into a plurality of groups; and an information creation module for extracting characteristic information of each of the plurality of groups, selecting a topic corresponding to the extracted characteristic information, and summarizing information about the group, thereby creating the web information.

The microblog information collection unit may include a search module for searching the microblogs using the keyword; an additional information extraction module for extracting additional information, including geographical location information, from the written information; and an Internet Protocol (IP) information storage module for storing a telephone number, an address, and location information corresponding to an IP address of a terminal that belongs to the additional information.

The context-aware information creation unit may include a geographical information storage module for storing geographical information in electronic map form; a mapping module for mapping the geographical information and the written information to each other; an information analysis module for creating integrated information by integrating the web information with the microblog information; and a context-aware information creation module for creating the context-aware information using the integrated information and results of the mapping of the geographical information and the written information to each other.

The context-aware information creation module may provide the context-aware information to a user, thereby enabling the user to become aware of the context based on the context-aware information.

In order to accomplish the above object, the present invention provides a context-aware method, including monitoring written information of one or more microblogs, and extracting at least one keyword corresponding to a set topic from the written information; collecting web information corresponding to the keyword from webpages; collecting microblog information corresponding to the written information including the keyword from the microblogs; creating context-aware information using the web information and the microblog information; and providing the context-aware information to a user.

The extracting the keyword may include storing multimedia information that is used to represent the written information; accessing the microblogs, and receiving the written information; analyzing a correlation between the multimedia information and the written information, and determining whether the written information is information corresponding to an abnormal context; and if the written information is information corresponding to an abnormal context, extracting at least one keyword corresponding to the abnormal context from the written information.

The abnormal context may be a context corresponding to at least one of a cyber attack, a natural disaster, gas leakage, or a traffic context.

The collecting the web information may include collecting webpages including the keyword; analyzing the collected webpages, and clustering analysis results into a plurality of groups; extracting characteristic information of each of the plurality of groups, and selecting a topic corresponding to the extracted characteristic information; summarizing information about the plurality of groups; and creating the web information including the characteristic information, topic, summarized information of each of the plurality of groups.

The collecting the microblog information may include searching the microblogs using the keyword; and extracting additional information, including geographical information, using the written information and a previously stored telephone number, address and location information corresponding to an IP address of a terminal.

The creating context-aware information may include storing geographical information in electronic map form; mapping the geographical information and the written information to each other; creating integrated information by integrating the web information with the microblog information; and creating the context-aware information using the integrated information and the results of the mapping of the geographical information and the written information to each other.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing the configuration of a context-aware apparatus according to an embodiment of the present invention;

FIG. 2 is a diagram showing the configuration of a microblog monitoring unit according to the embodiment of the present invention;

FIG. 3 is a diagram showing the configuration of a microblog information collection unit according to the embodiment of the present invention;

FIG. 4 is a diagram showing the configuration of a web information collection unit according to the embodiment of the present invention;

FIG. 5 is a diagram showing the configuration of a context-aware information creation unit according to the embodiment of the present invention;

FIG. 6 is a diagram showing context-aware information according to the embodiment of the present invention; and

FIG. 7 is a flowchart showing a method of becoming aware of the context according to an embodiment of the present invention.

### DESCRIPTION OF THE PREFERRED EMBODIMENTS

Reference now should be made to the drawings, in which the same reference numerals are used throughout the different drawings to designate the same or similar components.

The present invention will be described in detail with reference to the accompanying drawings. Here, repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated for clarity of description.

A context-aware apparatus and method according to embodiments of the present invention will be described in detail below with reference to the accompanying drawings.

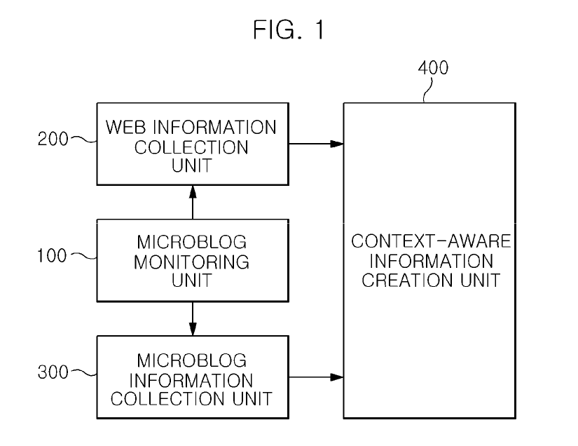

FIG. 1 is a diagram schematically showing the configuration of the context-aware apparatus according to the embodiment of the present invention.

First, the context-aware apparatus according to the embodiment of the present invention is configured to allow a topic to be selected from among a variety of abnormal contexts and become aware of an abnormal context corresponding to the set topic. Here, the abnormal context may include, for example, a cyber attack, a natural disaster such as an earthquake or a typhoon, gas leakage, and a traffic context, but is not limited thereto.

Referring to FIG. 1, the context-aware apparatus includes a microblog monitoring unit 100, a web information collection unit 200, a microblog information collection unit 300, and a context-aware information creation unit 400.

The microblog monitoring unit 100 monitors short sentence information (hereinafter referred to as “written information”) that users who use microblogs (hereinafter referred to as the “microblog users”) write in the microblogs, and extracts a corresponding keyword when the keyword corresponding to the set topic is present in the written information. Here, the written information of microblogs corresponds to information written in the microblogs of an expert, an expert group, an organization, and/or a company which provide abnormal context-related information, and is collected by periodic or aperiodic monitoring.

Thereafter, the microblog monitoring unit 100 transfers the extracted keyword to the web information collection unit 200 and the microblog information collection unit 300, and requests that information corresponding to the extracted keyword be searched.

The web information collection unit 200 collects web information corresponding to the keyword from webpages based on the transferred keyword. Here, the web information includes keyword-related detailed information and record-related information.

The microblog information collection unit 300 collects microblog information, including the writers of the text including the keyword and the location information of the writers.

The web information collection unit 200 and the microblog information collection unit 300 transfer the collected web information and microblog information to the context-aware information creation unit 400.

The context-aware information creation unit 400 analyzes the web information and the microblog information in an integrated fashion, and creates context-aware information based on analysis results. Thereafter, the context-aware information creation unit 400 transfers the created context-aware information to the outside, for example, a microblog, a webpage, the administrator's terminal, or a security context-aware console.

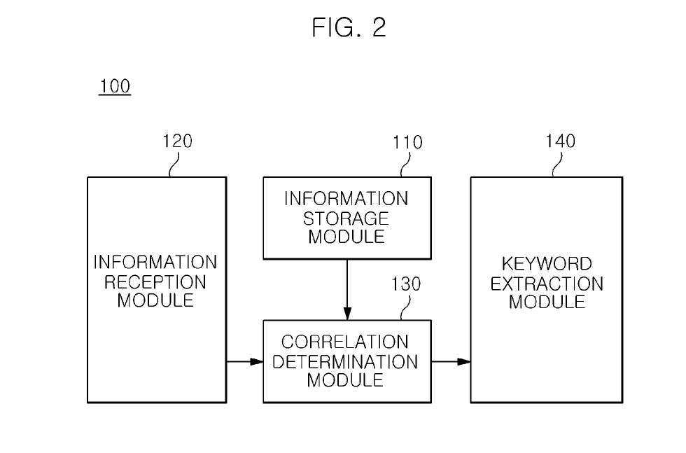

The microblog monitoring unit 100 will now be described in detail with reference to FIG. 2.

FIG. 2 is a diagram showing the configuration of the microblog monitoring unit according to the embodiment of the present invention.

Referring to FIG. 2, the microblog monitoring unit 100 includes an information storage module 110, an information reception module 120, a correlation determination module 130, and a keyword extraction module 140.

The information storage module 110 stores multimedia information, including text, images, etc. that can be used to represent the abnormal context. Here, the multimedia information may be defined by the administrator in advance, but is not limited thereto.

The information reception module 120 accesses the microblogs, and receives written information that the microblog users write in the microblogs. Here, the microblog users corresponds to an expert, an expert group, a company and/or a public organization related to the abnormal context, for example, a cyber attack, a natural disaster, gas leakage, or a traffic context.

The context-aware apparatus according to the embodiment of the present invention receives written information from the microblog users in real time, and therefore has the advantage of rapidly receiving information compared to conventional apparatuses that have become aware of an abnormal context.

The correlation determination module 130 analyzes the correlation between the written information and the multimedia information, and determines whether the written information corresponds to information about the abnormal context based on analysis results.

The keyword extraction module 140 extracts the keyword corresponding to the abnormal context from the written information if the written information corresponds to information about the abnormal context. Here, the keyword may be in various forms, for example, in the form of text such as a word or a sentence, or an image corresponding to the abnormal context, but is not limited thereto.

Thereafter, the keyword extraction module 140 transfers the extracted keyword to the web information collection unit 200 and the microblog information collection unit 300.

Then, the web information collection unit 200 and the microblog information collection unit 300 collect information related to the transferred keyword.

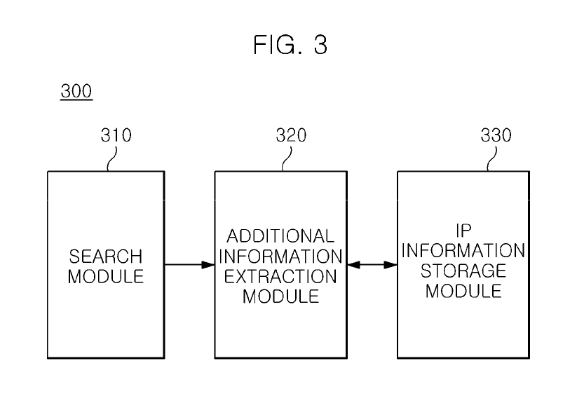

The microblog information collection unit 300 will now be described in detail with reference to FIG. 3.

FIG. 3 is a diagram showing the configuration of the microblog information collection unit according to the embodiment of the present invention.

First, the microblog information collection unit 300 receives a keyword from the microblog monitoring unit 100.

Referring to FIG. 3, the microblog information collection unit 300 includes a search module 310, an additional information extraction module 320, and an Internet Protocol (hereinafter referred to as “IP”) information storage module 330.

The search module 310 searches microblogs for written information, including the corresponding keyword, using the received keyword, and receives written information, that is, microblog information, including the keyword, that has been selected from search results.

The written information that each microblog user writes in his or her corresponding microblog includes not only text, that is, the content of short sentence information, but also information about a uniform resource locator (URL) address, the time, location information defined by the user, and the IP address of a terminal which was used to write the text.

The IP information storage module 330 is storage that stores information about a company, and an administrative domain as well as information about the telephone number, address, latitude and longitude of the administrator, which correspond to the IP addresses of additional information. Here, the information stored in the IP information storage module 330 may be in various forms, for example, in database or file form, but is not limited thereto.

In addition to the content of the text, the additional information extraction module 320 extracts additional information from the written information. Here, the additional information includes URL information corresponding to a URL address and the IP address information of a terminal. Detailed information corresponding to the additional information is extracted using the IP information storage module 330.

Furthermore, the additional information extraction module 320 transfers the microblog information and the additional information to the context-aware information creation unit 400.

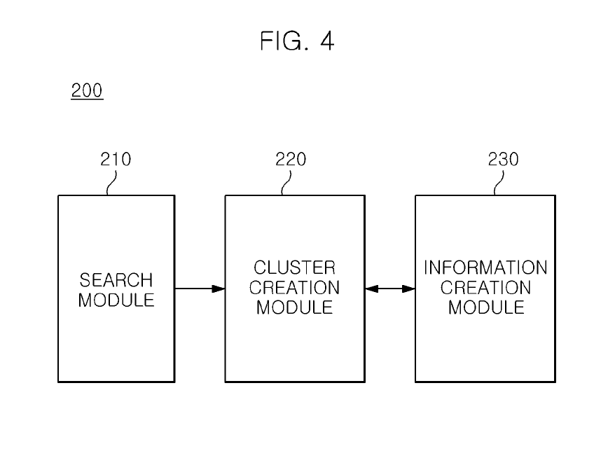

The web information collection unit 200 will now be described in detail with reference to FIG. 4.

FIG. 4 is a diagram showing the configuration of the web information collection unit according to the embodiment of the present invention.

First, the web information collection unit 200 receives a keyword from the microblog monitoring unit 100.

Referring to FIG. 4, the web information collection unit 200 includes a search module 210, a cluster creation module 220, and an information creation module 230.

The search module 210 collects webpages, including the keyword, from webpages existing on the Internet using the received keyword.

The cluster creation module 220 analyzes the content of the collected webpages, and clusters analysis results into a plurality of groups.

The information creation module 230 extracts characteristic information from each of the plurality of groups, selects a topic corresponding to the extracted characteristic information, and summarizes information about the group. Here, the topic of each group and the summarized information of the group correspond to web information.

Thereafter, the information creation module 230 transfers the web information to the context-aware information creation unit 400.

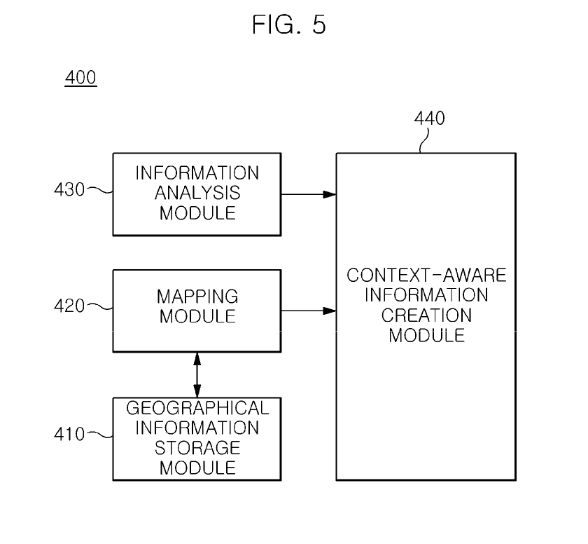

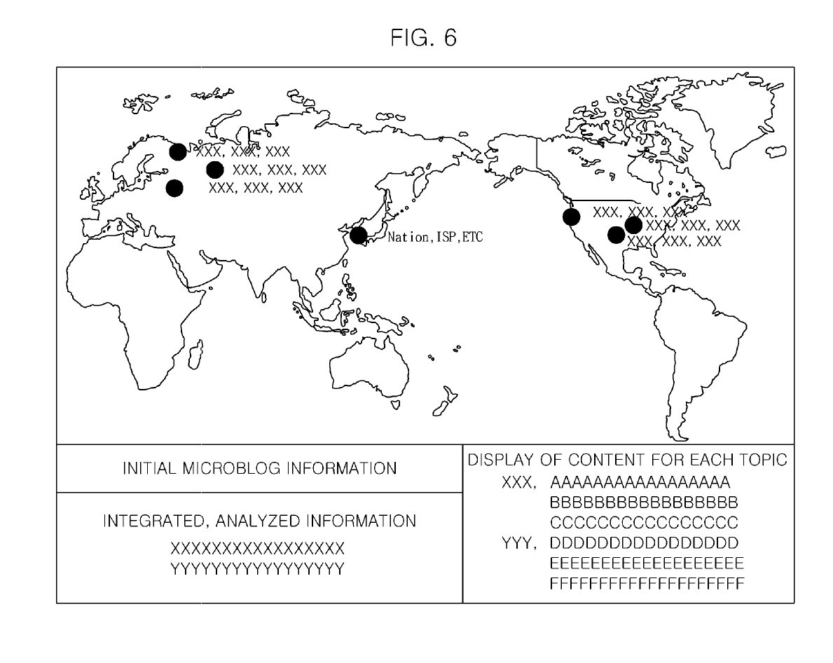

The context-aware information creation unit 400 will now be described in detail with reference to FIGS. 5 and 6.

FIG. 5 is a diagram showing the configuration of the context-aware information creation unit according to the embodiment of the present invention, and FIG. 6 is a diagram showing context-aware information according to the embodiment of the present invention.

First, the context-aware information creation unit 400 receives web information from the web information collection unit 200, and receives microblog information and additional information from the microblog information collection unit 300.

Referring to FIG. 5, the context-aware information creation unit 400 includes a geographical information storage module 410, a mapping module 420, an information analysis module 430, and a context-aware information creation module 440.

The geographical information storage module 410 stores geographical information such as electronic map information. Here, the electronic map information may be in various forms such as in a database or file form, but is not limited thereto. Furthermore, the geographical information storage module 410 may be, for example, in the form of an Internet electronic map.

The mapping module 420 maps the geographical location information and geographical information of the additional information to each other, and shows mapping results on a map.

The information analysis module 430 integrates the web information with the microblog information into integrated information, and analyzes the integrated information.

The context-aware information creation module 440 creates context-aware information using the results of the mapping of the geographical location information and the geographical information to each other and the integrated information. Here, the context-aware information is information that intuitively represents a context. Furthermore, the context-aware information creation module 440 represents the context-aware information via various media such as a microblog, a webpage, and an abnormal context-aware console.

Referring to FIG. 6, the context-aware information includes results that are obtained by classifying information, collected by web searching, and the results of the mapping of the geographical location information, corresponding to information collected by searching microblogs, and the geographical information to each other according to their topics. Furthermore, the context-aware information corresponds to results that are obtained by integrating the initial content of a microblog, web search results and microblog search results.

The user receives such context-aware information, and therefore can intuitively become aware of an abnormal context related to the specific context.

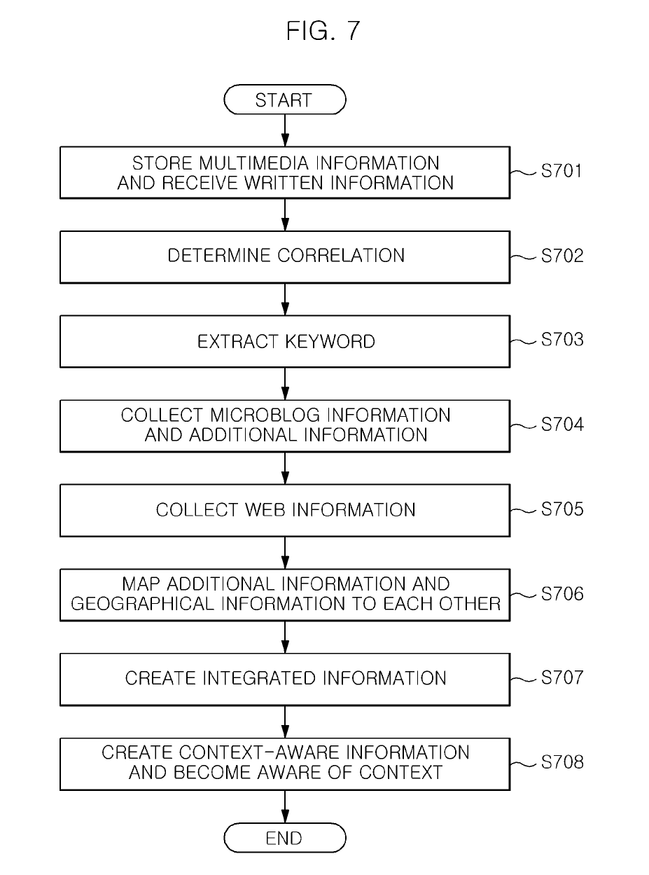

A method of becoming aware of a context will now be described in detail with reference to FIG. 7.

FIG. 7 is a flowchart showing a method of becoming aware of a context according to the embodiment of the present invention.

For example, the context-aware apparatus sets a cyber attack as an abnormal context.

Referring to FIG. 7, the context-aware apparatus stores multimedia information corresponding to the abnormal context and receives information written by microblog users at step S701. Here, the microblog users correspond to an expert, an expert group, a related company and/or a public organization related to the abnormal context such as a cyber attack, a natural disaster, gas leakage, or a traffic context.

The context-aware apparatus analyzes the correlation between the multimedia information and the written information and determines whether the written information corresponds to information about an abnormal context based on analysis results at step S702.

The context-aware apparatus extracts a keyword corresponding to the abnormal context from the written information if the written information corresponds to information about the abnormal context at step S703. For example, when the information written by a microblog user is that “currently, an Internet worm using the source port number 1434 has broken out,” the context-aware apparatus extracts keywords “Internet worm” and “source port 1434”.

The context-aware apparatus collects written information including the extracted keyword in the microblogs, that is, microblog information, and the additional information of the corresponding written information at step S704. Here, the additional information includes the IP addresses and location information of the writers of the written information, that is, microblog users, and the countries and organizations including those IP addresses.

The context-aware apparatus collects web information corresponding to webpages including the keywords at step S705. In detail, the context-aware apparatus analyzes webpages collected using the keywords, and clusters analysis results into a plurality of groups. Thereafter, the context-aware apparatus extracts the characteristic information of each of the plurality of groups, selects a topic (for example, the definition of an Internet worm, a damage case, a solution, or the like) corresponding to the extracted characteristic information, and summarizes information about the group. In this case, the topic of each group and the summarized information of the group correspond to the web information.

The context-aware apparatus maps the geographical location information and geographical information of the additional information to each other at step S706. In this case, the context-aware apparatus shows mapping results on a map, as shown in FIG. 6. Furthermore, the context-aware apparatus may derive the common characteristics of the microblog users and create statistical information, based on information about IP addresses corresponding to additional information.

The context-aware apparatus creates integrated information by integrating the web information with the microblog information at step S707.

The context-aware apparatus creates context-aware information using the results of the mapping of the geographical location information and the geographical information to each other and the integrated information and provides the context-aware information to the user, thereby enabling the user to become aware of the context based on the context-aware information at step S708.

As a result, the user can intuitively become aware of integrated information, including, for example, the area where an Internet worm has broken out, the cases of the breakout of a similar Internet worm, and a method for dealing with the Internet worm, using the context-aware information.

As described above, the context-aware apparatus and method according to the embodiments of the present invention have the advantage of not requiring a user's intervention because they automatically become aware of an abnormal context by monitoring microblog services. Furthermore, the context-aware apparatus and method according to the embodiments of the present invention have the advantage of being able to provide elaborate and a variety of information to a user because they automatically become aware of the abnormal context, search for corresponding web information and microblog information and analyze a correlation.

Furthermore, the context-aware apparatus and method according to the embodiments of the present invention have the advantage of enabling a user to rapidly become aware of and deal with an abnormal context because they provide integrated information, including current context information, statistical information and a solution related to the abnormal context, in conjunction with geographical information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A context-aware apparatus, comprising:
a microblog monitoring unit for monitoring written information of one or more microblogs, and extracting at least one keyword corresponding to a set topic from the written information;
a web information collection unit for collecting web information corresponding to the keyword from webpages;
a microblog information collection unit for collecting microblog information corresponding to the written information including the keyword from the microblogs; and
a context-aware information creation unit for creating context-aware information using the web information and the microblog information.

2. The context-aware apparatus as set forth in claim 1, wherein the written information corresponds to information that was written by users of the microblogs based on monitoring results that are obtained in such a way that the users monitor information related to an abnormal context corresponding to at least one of a cyber attack, a natural disaster, gas leakage, or a traffic context.

3. The context-aware apparatus as set forth in claim 1, wherein the microblog monitoring unit comprises:
an information storage module for storing multimedia information that is used to represent the written information;
an information reception module for accessing the microblogs and receiving the written information;
a correlation determination module for analyzing a correlation between the multimedia information and the written information and determining whether the written information is information corresponding to the abnormal context based on analysis results; and
a keyword extraction module for extracting at least one keyword corresponding to the abnormal context from the written information if the written information is information corresponding to the abnormal context.

4. The context-aware apparatus as set forth in claim 1, wherein the web information collection unit comprises:
a search module for collecting webpages including the keyword;
a cluster creation module for analyzing the collected webpages and clustering analysis results into a plurality of groups; and
an information creation module for extracting characteristic information of each of the plurality of groups, selecting a topic corresponding to the extracted characteristic information, and summarizing information about the group, thereby creating the web information.

5. The context-aware apparatus as set forth in claim 1, wherein the microblog information collection unit comprises:
a search module for searching the microblogs using the keyword;
an additional information extraction module for extracting additional information, including geographical location information, from the written information; and
an Internet Protocol (IP) information storage module for storing a telephone number, an address, and location information corresponding to an IP address of a terminal that belongs to the additional information.

6. The context-aware apparatus as set forth in claim 1, wherein the context-aware information creation unit comprises:
a geographical information storage module for storing geographical information in electronic map form;
a mapping module for mapping the geographical information and the written information to each other;
an information analysis module for creating integrated information by integrating the web information with the microblog information; and
a context-aware information creation module for creating the context-aware information using the integrated information and results of the mapping of the geographical information and the written information to each other.

7. The context-aware apparatus as set forth in claim 6, wherein the context-aware information creation module provides the context-aware information to a user, thereby enabling the user to become aware of the context based on the context-aware information.

8. A context-aware method, comprising:
monitoring written information of one or more microblogs, and extracting at least one keyword corresponding to a set topic from the written information;
collecting web information corresponding to the keyword from webpages;
collecting microblog information corresponding to the written information including the keyword from the microblogs;
creating context-aware information using the web information and the microblog information; and
providing the context-aware information to a user.

9. The context-aware method as set forth in claim 8, wherein the extracting the keyword comprises:
storing multimedia information that is used to represent the written information;
accessing the microblogs, and receiving the written information;
analyzing a correlation between the multimedia information and the written information, and determining whether the written information is information corresponding to an abnormal context; and
if the written information is information corresponding to an abnormal context, extracting at least one keyword corresponding to the abnormal context from the written information.

10. The context-aware method as set forth in claim 9, wherein the abnormal context is a context corresponding to at least one of a cyber attack, a natural disaster, gas leakage, or a traffic context.

11. The context-aware method as set forth in claim 8, wherein the collecting the web information comprises:
collecting webpages including the keyword;
analyzing the collected webpages, and clustering analysis results into a plurality of groups;
extracting characteristic information of each of the plurality of groups, and selecting a topic corresponding to the extracted characteristic information;
summarizing information about the plurality of groups; and
creating the web information including the characteristic information, topic, summarized information of each of the plurality of groups.

12. The context-aware method as set forth in claim 8, wherein the collecting the microblog information comprises:
searching the microblogs using the keyword; and
extracting additional information, including geographical information, using the written information and a previously stored telephone number, address and location information corresponding to an IP address of a terminal.

13. The context-aware method as set forth in claim 8, wherein the creating context-aware information comprises:
storing geographical information in electronic map form;
mapping the geographical information and the written information to each other;
creating integrated information by integrating the web information with the microblog information; and
creating the context-aware information using the integrated information and the results of the mapping of the geographical information and the written information to each other.
